(19) United States
(12) Patent Application Publication
(10) Pub. No.: US 2012/0249529 A1
(43) Pub. Date: Oct. 4, 2012

(54) 3D IMAGE DISPLAYING APPARATUS, 3D IMAGE DISPLAYING METHOD, AND 3D IMAGE DISPLAYING PROGRAM

(75) Inventors: Tetsuya MATSUMOTO, Tokyo (JP); Kei YAMAJI, Tokyo (JP)

(73) Assignee: FUJIFILM CORPORATION, Tokyo (JP)

(21) Appl. No.: 13/402,358

(22) Filed: Feb. 22, 2012

(30) Foreign Application Priority Data
Mar. 31, 2011 (JP) 2011-081302

(51) Int. Cl. G06T 15/00

(52) U.S. Cl. 345/419

(57) ABSTRACT

A 3D image displaying apparatus includes a 3D image displaying device for displaying a plurality of 2D images sharing at least part of shot subjects with one another so as to display a 3D image in which at least a portion of the 2D images is perceived by a viewer as a stereo image with a specified depth and a display controlling device for making a depth of the 3D image vary so as to provide a plurality of 3D images with different depths, and causing the 3D images with different depths to be displayed in list form on the 3D image displaying device. A 3D image displaying method displays the 2D images and carries out the control. A 3D image displaying program causes a computer to perform the steps of the method. A computer readable storage medium stores the program.

### BACKGROUND OF THE INVENTION

The present invention relates to 3D (three-dimensional) image displaying apparatus, 3D image displaying methods and 3D image displaying programs adapted to display a 3D (three-dimensional) image (stereoscopic image) generated from a plurality of images, as well as recording media having such programs recorded thereon.

It is known that a human being perceives the third dimension of an object by viewing the object with his/her right and left eyes at different angles and distances, that is to say, owing to the difference between the appearance of the object as viewed with the right eye and that of the object as viewed with the left eye. Such difference in appearance, or spatial disparity, between an object viewed with the right eye and the same object viewed with the left eye is referred to as parallax. To human beings perceiving the third dimension according to the magnitude of the parallax, an image with a larger parallax appears to protrude to a greater extent.

Up until today proposed were methods of exploiting the principle of third dimension perception by human beings to make people perceive 2D (two-dimensional) images (planar images) as stereo images. As an example: If one and the same subject is shot at different angles to obtain images for right eye and for left eye, and the image for right eye is presented to the right eye of a person, while the image for left eye is presented to the left eye, the person perceives that he/she is viewing a stereo image of the subject because there is a certain parallax between the images for right eye and for left eye. Hereafter, the 2D images as displayed so that they may appear to people stereoscopic are referred to as 3D images.

Among various technologies for presenting an image for right eye to the right eye while presenting an image for left eye to the left eye so as to provide a 3D image, parallax barrier technology and lenticular technology may be mentioned as typical ones. In these technologies, an image for left eye and an image for right eye are each decomposed in the form of vertical strips, and the strips of the image for left eye and of the image for right eye are alternately arranged on the same screen to form one image. In the case of parallax barrier technology, only the image for left eye is seen with the left eye, and only the image for right eye with the right eye, of a person viewing the formed image through strip-shaped slits. In the case of lenticular technology, a lenticular lens provided on the screen, on which the formed image is displayed, makes such restriction that only the image for left eye is seen with the left eye while only the image for right eye is seen with the right eye. In addition, 3D printing technology for printing 3D images based on a similar principle concerning lenticular lenses has been proposed.

Since the third dimension perception by human beings is according to the parallax, the stereoscopic impression which is given to people can be modified by adjusting the parallax. In the parallax barrier technology or lenticular lens technology, for instance, people have a stronger stereoscopic impression if an image for left eye and an image for right eye displayed on a screen are displaced from each other in such directions that they do not overlap, so as to increase the parallax between the images for left eye and for right eye. JP 2000-78615 A discloses the digital broadcast receiver in which 3D video images are freely adjustable in parallax.

A camera with a 3D photographing mode, and so forth have been proposed in order to obtain images for right eye and for left eye available for stereopsis in such a way as above. JP 2008-172342 A and JP 2004-104330 A each disclose an apparatus for automatically selecting from among a plurality of images those which are able to be used as images for right eye and for left eye available for stereopsis. A combination of images for right eye and for left eye available for stereopsis is stored as 3D image data, with the images being associated with each other.

Recently, it is often the case that the orderer who is going to order a print of an image taken with a digital camera selects the image to be printed while viewing images displayed on a display device. If printing of 2D image data is to be ordered, the image to be printed is selected, the print size is selected, and the area of the image that is to be printed is confirmed before an order is placed. On the other hand, if printing of 3D image data is to be ordered, it is required not only to make such selections as made during the order for printing of 2D image data but determine whether to have the 3D image data printed as a 2D image or a 3D image. If the 3D image data is to be printed as a 2D image, it is further required to determine whether the image for left eye or for right eye is printed. If the data is to be printed as a 3D image, it is required to select the stereoscopic impression of a 3D image printed. In other words, the order for printing of 3D image data is inconvenient as compared with the order for printing of 2D image data because of a larger number of selections and determinations to be made. In particular, it is desirable that the selected stereoscopic impression of a 3D image printed is confirmed by the orderer with his/her own eyes before an order is placed.

In the digital broadcast receiver as described in JP 2000-78615 A, 3D images are adjustable in parallax, although it is not possible to confirm the stereoscopic impression of the 3D image as adjusted in parallax. In the apparatus as described in JP 2008-172342 A and JP 2004-104330 A, images suitable for stereopsis are merely selected, and it is uncertain whether or not an image generated from the selected image pair is a 3D image giving a stereoscopic impression desirable for the operator.

### SUMMARY OF THE INVENTION

The present invention has been made in view of the above facts. It is an object of the present invention to provide a 3D image displaying apparatus, a 3D image displaying method and a 3D image displaying program, each allowing display of the 3D images from which a user is able to select with ease a 3D image giving a desired stereoscopic impression, as well as a recording medium having such a program recorded thereon.

In order to achieve the above object, the present invention provides a three-dimensional image displaying method for displaying a plurality of three-dimensional images, each being constructed from a two-dimensional image pair composed of two two-dimensional images taken, wherein the three-dimensional images to be displayed are different from one another in depth, and are displayed in list form; and the three-dimensional images to be displayed share at least part of shot subjects with one another.

In order to achieve the above object, the present invention provides a three-dimensional image displaying apparatus comprising: a three-dimensional image displaying device for displaying a plurality of two-dimensional images sharing at least part of shot subjects with one another so as to display a three-dimensional image in which at least a portion of the two-dimensional images is perceived by a viewer as a stereo image with a specified depth; and a display controlling device for making a depth of the three-dimensional image vary so as to provide a plurality of three-dimensional images with different depths, and causing the three-dimensional images with different depths to be displayed in list form on the three-dimensional image displaying device.

In the concept of the 3D image displaying device as above, included are not only display means available for stereopsis with the naked eye but the display means which are available for stereopsis if a viewer wears glasses formed of polarizing plates or the like. The term “3D image” refers to not an image completely stereoscopic but the 2D images as displayed so that a viewer may perceive them stereoscopic. Objects contained in a 3D image do not need to appear to a viewer stereoscopic in whole, that is to say, they may appear stereoscopic at least in part.

The term “a plurality of 2D images sharing at least part of shot subjects with one another” refers to the images which appear stereoscopic at least in part if stereoscopically displayed by the 3D image displaying device. Specifically, the images are those which share at least part of shot subjects with one another, and are almost identical to one another in composition including background and so forth.

The images to be displayed in list form may or may not be displayed at a time. In other words, the images reduced in size which are to be displayed in list form may also be displayed sequentially by changing the displayed images using a scroll bar or the like.

It is preferable that the three-dimensional image displaying apparatus according to the present invention further comprises an image extracting device for extracting from a plurality of two-dimensional images stored in a storage medium those two-dimensional images which are displayable by the three-dimensional image displaying device as a three-dimensional image if they are combined together, wherein the display controlling device makes the depth of the three-dimensional image vary by forming different combinations of the two-dimensional images as extracted by the image extracting device, and causes three-dimensional images generated from the different combinations of the two-dimensional images to be displayed in list form on the three-dimensional image displaying device.

The configuration as above allows automatic extraction of images suitable for stereopsis from the images stored in a storage medium and, accordingly, makes it possible to extract images not expected by a viewer to be combined together. The viewer may select a desired 3D image by mutually comparing 3D images generated from the automatically extracted images.

The display controlling device may make the depth of the three-dimensional image vary by displacing the two-dimensional images displayed on the three-dimensional image displaying device.

The configuration as above allows the parallax between 2D images to vary, that is to say, allows 3D images with different depths to be generated from the same combination of 2D images.

The display controlling device preferably causes a plurality of two-dimensional images constituting the three-dimensional images with different depths to be displayed as two-dimensional images along with the three-dimensional images, with the three-dimensional images and the two-dimensional images being displayed in list form.

If the images are displayed as above, a viewer is able to select a desired image by comparing the 3D images and the 2D images with each other.

The image extracting device preferably extracts the two-dimensional images which meet a predetermined condition, based on a file format, image analysis, or two-dimensional image tag information.

If the 2D images which meet a predetermined condition are extracted based on the file format, image analysis, or 2D image tag information, images available for stereopsis are extracted with efficiency.

The display controlling device preferably causes three-dimensional images to be displayed in list form in such an order that a three-dimensional image determined to be more suitable for stereopsis based on the predetermined condition is displayed with a higher priority.

If the images are displayed as above, a viewer is able to examine initially those images which are determined to be suitable for stereopsis, so that a desired image is easy to find.

The display controlling device preferably causes an area cut off during generation of the three-dimensional image to be displayed along with the three-dimensional image.

Such display of an area cut off during the generation of a 3D image allows a viewer to identify the area, and recognize that the area to be cut off varies with the 3D image depth.

The three-dimensional images with different depths as displayed on the three-dimensional image displaying device are preferably three-dimensional images displayed in order to select from among them those to be printed.

It is preferable that the three-dimensional image displaying apparatus of the present invention further comprises a device for selecting a three-dimensional image to be printed from among the three-dimensional images with different depths as displayed on the three-dimensional image displaying device.

It is also preferable that the three-dimensional image displaying apparatus of the present invention further comprises a print size designating device for designating a print size for an image.

The display controlling device preferably causes a frame with a size resulting from the print size as designated by the print size designating device to be displayed so that it may be superimposed on the three-dimensional image.

If the frame is displayed as above, it is readily possible for a viewer to select, for the purpose of printing in particular, the 3D image which has a desired depth to give a desired stereoscopic impression, and which the viewer wants to be printed. Moreover, since the area to be actually printed is made definite, printing of an image in an unexpected range is prevented.

The present invention may also be implemented as a three-dimensional image displaying program for causing a computer to perform as its procedures: a display step of displaying a plurality of two-dimensional images sharing at least part of shot subjects with one another so as to display a three-dimensional image in which at least a portion of the two-dimensional images is perceived by a viewer as a stereo image with a specified depth; and a control step of carrying out control so that three-dimensional images differing from one another in depth may be displayed in list form in the display step.

It is also possible to implement the present invention as a computer readable recording medium with the three-dimensional image displaying program as above recorded thereon.

The present invention thus allows display of the 3D images from which a user is able to select with ease a 3D image giving a desired stereoscopic impression.

### BRIEF DESCRIPTION OF THE DRAWINGS

In the accompanying drawings:

FIG. 1 is a diagram showing exemplary views from the right eye and from the left eye;

FIGS. 2A through 2D are diagrams illustrating the 3D image depth with respect to the cases where an image for right eye and an image for left eye are displayed so that they may be superimposed on each other, where an image for right eye and an image for left eye are displayed so that they may be displaced from each other, where an image for right eye and an image for left eye are displayed so that they may be further displaced from each other, and where the parallax between images for right eye and for left eye is of another magnitude, respectively;

FIG. 3 is a functional block diagram of the 3D image displaying apparatus according to Embodiment 1 of the present invention;

FIG. 4 is a diagram showing an exemplary image editing screen displayed on a monitor;

FIG. 5 is a diagram illustrating another way of displaying images in a selected image displaying section;

FIG. 6 is a diagram illustrating another way of displaying 3D images in the selected image displaying section;

FIG. 7 is a diagram illustrating yet another way of displaying 3D images in the selected image displaying section;

FIG. 8 is a diagram showing another exemplary image editing screen displayed on the monitor;

FIG. 9 is a diagram showing yet another exemplary image editing screen displayed on the monitor;

FIG. 10 is a functional block diagram of the 3D image displaying apparatus according to Embodiment 2 of the present invention;

FIG. 11 is a diagram showing an exemplary image editing screen displayed on a monitor of the 3D image displaying apparatus according to Embodiment 2;

FIG. 12 is a diagram showing images included in a group of three or more images available for stereopsis;

FIG. 13 is a diagram showing exemplary images displayed in a selected image displaying section after a group of three or more images available for stereopsis is selected;

FIG. 14 is a diagram representing, by numbers, combinations of two 2D images constituting 3D images displayed in a selected image displaying section;

FIG. 15A is a diagram illustrating the case where one 3D image is selected from among 3D images generated from different combinations of 2D images and displayed in list form, while FIG. 15B is a diagram showing a screen displayed after the 3D image is selected; and

FIG. 16 is a diagram showing an image editing screen displayed if a 3D image is to be generated from two images selected at will by a user.

### DETAILED DESCRIPTION OF THE INVENTION

In the following, the 3D image displaying apparatus, the 3D image displaying method and the 3D image displaying program according to the present invention are detailed based on the preferred embodiments as shown in the accompanying drawings.

First of all, description is made on 3D images.

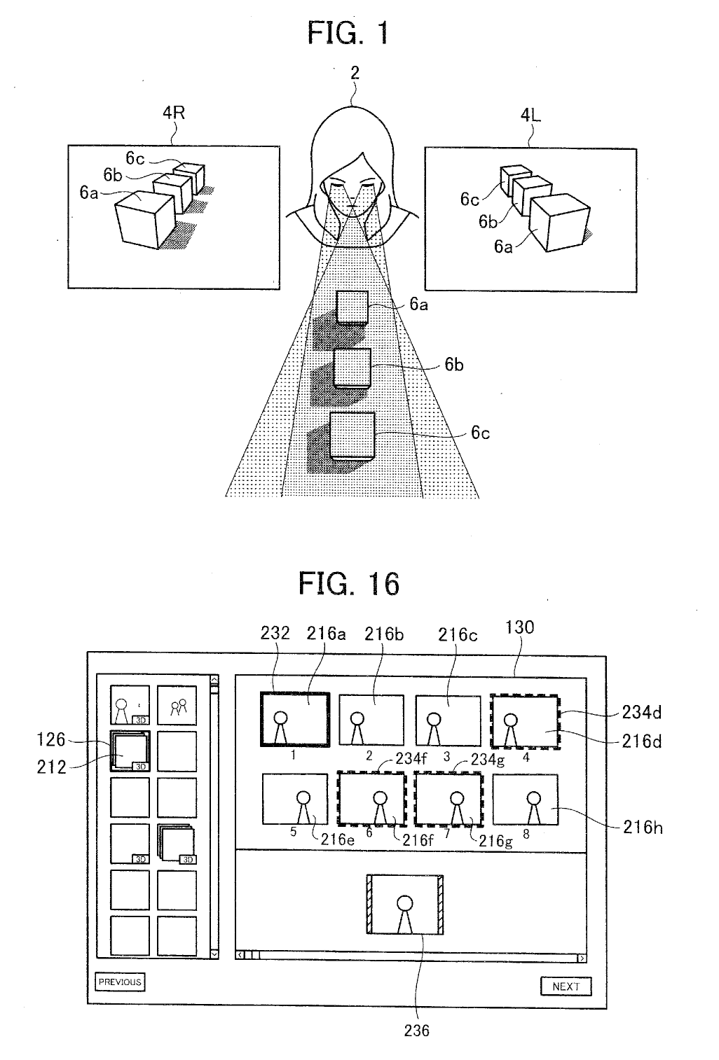

FIG. 1 shows exemplary views from the right eye and from the left eye. In FIG. 1, it is assumed that a person 2 views cubes 6a through 6c aligned in tandem. The person 2 viewing the cubes 6a through 6c sees a view 4L with the left eye, and a view 4R with the right eye. The cubes 6a through 6c in the view 4L are seen differently from those in the view 4R depending on the distance between the person 2 and the cubes 6a through 6c, that is to say, a cube nearer to the person 2 is seen more differently between the left and right eyes with a larger parallax. In the case as shown, the cube 6a is seen with the largest parallax. A human being perceives the third dimension by seeing different views with the right and left eyes and merging the views together in the brain, whereupon an object seen with a larger parallax is perceived to be nearer. On the contrary, if an image for left eye containing three cubes, such as the view 4L, is shown to the left eye of a human being, and an image for right eye containing the same cubes as the image for left eye, such as the view 4R, is shown to the right eye, the three cubes appear to the human being stereoscopic. The stereoscopic impression given to the human being may be modified by adjusting the parallax between the images for left eye and for right eye.

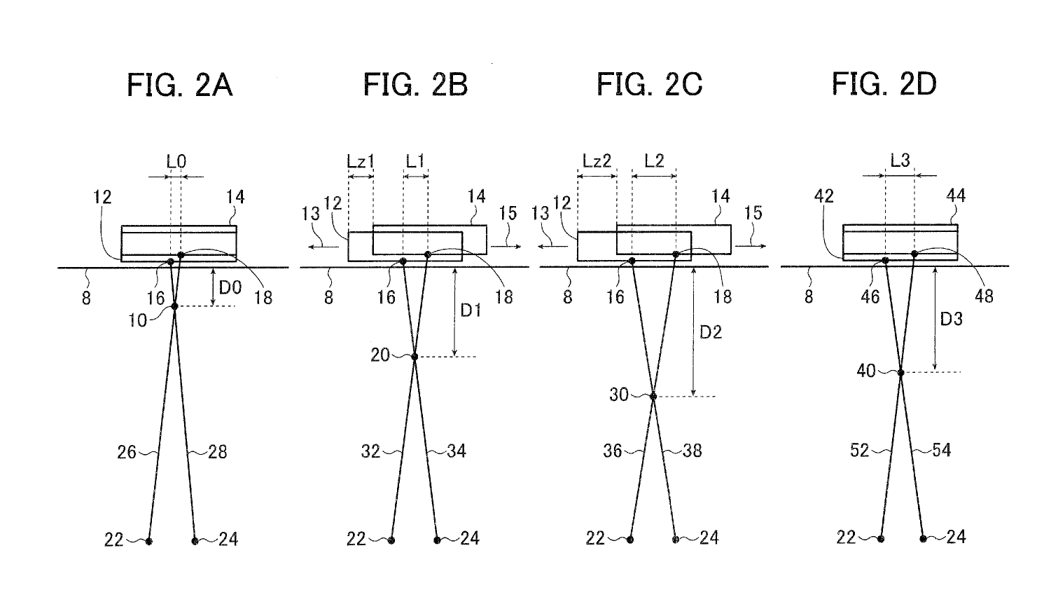

FIGS. 2A through 2D each representing the 3D display unit as seen from above and a person's lines of sight are used to make description on the principles of a 3D display unit for displaying a 3D image by presenting different images to the right and left eyes. On a 3D display unit 8, an image for right eye 12 and an image for left eye 14 are displayed. The image for right eye 12 is only presented to the right eye observing from a point 24. The image for left eye 14 is only presented to the left eye observing from a point 22. With the image for right eye 12 and the image for left eye 14 being displayed on the 3D display unit 8, there is essentially no displacement between the 3D display unit 8, the image for right eye 12 and the image for left eye 14 in vertical directions in the drawing plane. For a better understanding of the figures, however, the 3D display unit 8, the image for right eye 12 and the image for left eye 14 as shown are displaced from one another in vertical directions in the drawing plane. In addition, neither of the image for right eye 12 and the image for left eye 14 actually has the thickness as shown because they are merely images displayed on the 3D display unit 8.

In FIG. 2A, the image for right eye 12 and the image for left eye 14 are displayed on the 3D display unit 8 with no displacement therebetween in horizontal directions in the drawing plane. It is assumed that a point 16 representing a point on a subject is located on the image for right eye 12, and a point 18 representing the same point of the same subject is located on the image for left eye 14. Points located on an image for right eye and an image for left eye, respectively, and representing the same point on the same subject, such as the points 16 and 18, are hereafter referred to as “corresponding points.” The image for right eye 12 and the image for left eye 14 are images obtained by shooting one and the same subject at different angles. There is accordingly a certain parallax between the two images 12 and 14, so that the corresponding points 16 and 18 are located with a horizontal disparity of L0 therebetween even though the image for right eye 12 and the image for left eye 14 are displayed in an absolutely superimposed manner.

A person looking at the 3D display unit 8 with the images 12 and 14 displayed thereon as above perceives the point on the subject that is represented by the points 16 and 18 to be present at a point 10, namely, the point at which a line of sight 26 of the left eye directed to the point 18 and a line of sight 28 of the right eye directed to the point 16 intersect with each other. In other words, the subject as represented by the points 16 and 18 appears to protrude from the 3D display unit 8 by a distance of D0 between the 3D display unit 8 and the point 10. The distance of protrusion from the 3D display unit 8 is hereafter referred to as “depth of a 3D image,” or “3D image depth.” In the case as shown, the 3D image depth is D0, the distance between the 3D display unit 8 and the point 10.

In the 3D display unit 8 as above, the magnitude of the parallax may be caused to vary by displaying the image for right eye 12 and the image for left eye 14 with a horizontal displacement therebetween. The length of horizontal displacement between an image for right eye and an image for left eye is hereafter referred to as “amount of displacement.” If an image for right eye and an image for left eye are displayed in an absolutely superimposed manner, the amount of displacement measures zero. Since the third dimension perception by human beings is according to the parallax, and the magnitude of the parallax is adjustable with the amount of displacement, the stereoscopic impression (or, the depth) of a 3D image can be modified by adjusting the amount of displacement between the image for right eye 12 and the image for left eye 14.

FIG. 2B shows the 3D image depth obtained if the image for right eye 12 and the image for left eye 14 as displayed are displaced from each other by a length of Lz1. The image for right eye 12 and the image for left eye 14 as shown in FIG. 2A are moved leftward (in the direction of an arrow 13) and rightward (in the direction of an arrow 15), respectively, so as to displace them from each other with an amount of displacement of Lz1 as shown in FIG. 2B. In the case as shown, the distance between the points 16 and 18 measures L1 (=L0+Lz1). The images 12 and 14 as displaced from each other as above give people the illusion that the subject as represented by the points 16 and 18 is present at a point 20, namely, the point at which a line of sight 32 of the left eye directed to the point 18 and a line of sight 34 of the right eye directed to the point 16 intersect with each other. The distance between the 3D display unit 8 and the point 20 is D1 (>D0), so that the 3D image depth for the subject is D1 in the case as shown.

FIG. 2C shows the 3D image depth obtained if the image for right eye 12 and the image for left eye 14 as displayed are displaced from each other by a length of Lz2. The image for right eye 12 and the image for left eye 14 as shown in FIG. 2B are further moved leftward (in the direction of an arrow 13) and rightward (in the direction of an arrow 15), respectively, so as to displace them from each other with an amount of displacement of Lz2 as shown in FIG. 2C. In the case as shown, the distance between the points 16 and 18 measures L2 (=L0+Lz2). The images 12 and 14 as displaced from each other as above give people the illusion that the subject as represented by the points 16 and 18 is present at a point 30, namely, the point at which a line of sight 36 of the left eye directed to the point 18 and a line of sight 38 of the right eye directed to the point 16 intersect with each other. The distance between the 3D display unit 8 and the point 30 is D2 (>D1), so that the 3D image depth for the subject is D2 in the case as shown. In other words, the 3D image depth perceived by a person looking at the 3D display unit 8 is allowed to vary by changing the amount of displacement. In this regard, the image for right eye 12 and the image for left eye 14 are reduced in overlapping area if they are displayed with a displacement therebetween. As a result, a 3D image displayed is an image with both horizontal end areas cut off as compared with the images 12 and 14. Areas cut off from a 3D image become larger as the amount of displacement is increased.

It is conventional that an image for right eye and an image for left eye are obtained by shooting a subject in the positions which are horizontally shifted with respect to the subject. The distance between the corresponding points located on an image for right eye and an image for left eye, respectively, that is to say, the magnitude of the parallax can be changed by changing the distance between the positions in which the images for right eye and for left eye are taken, respectively. The depth of a 3D image displayed on the 3D display unit 8 will vary with the magnitude of the parallax. FIG. 2D shows the 3D image depth which is brought about by the parallax between images for right eye and for left eye that is different in magnitude from the parallax in the case as shown in FIG. 2A. On the 3D display unit 8 as shown in FIG. 2D, an image for right eye and an image for left eye are displayed with no displacement therebetween in horizontal directions in the drawing plane, which is similar to the case of FIG. 2A.

In FIG. 2D, the distance between a corresponding point 46 on an image for right eye 42 and a corresponding point 48 on an image for left eye 44 measures L3 (>L0). A person looking at the 3D display unit 8 with the images 42 and 44 displayed thereon as above perceives the point on a subject that is represented by the points 46 and 48 to be present at a point 40, namely, the point at which a line of sight 52 of the left eye directed to the point 48 and a line of sight 54 of the right eye directed to the point 46 intersect with each other. In the case as shown, the 3D image depth for the subject as represented by the points 46 and 48 is D3 (>D0). In other words, a 3D image displayed on the 3D display unit 8 has a greater depth as the parallax between images for right eye and for left eye is increased.

As described above, the 3D display unit 8 causes people to perceive 2D images as a 3D image, by utilizing the parallax between the corresponding points located on an image for right eye and an image for left eye, respectively, and the amount of displacement between the images for right eye and for left eye. Although not shown, similar principles may be exploited to express the depth of a 3D image so that people may perceive an object in the image to be retracting in the back of the 3D display unit 8.

If the amount of displacement is too large, the eyes of a user is overloaded, and stereopsis is no more possible due to the structure of human eyes. The range in which the amount of displacement is selectable depends on the horizontal length of a 3D image (length in the directions in which an image for right eye and an image for left eye are displaced from each other), and the amount of displacement is able to be selected in a wider range as the image size is larger.

As evident from the principles of the 3D display unit 8 as described above, the depth of a 3D image is allowed to vary by changing the amount of displacement, which also applies to the printing of a 3D image. In addition, a 3D image is seen differently from individual to individual, so that there are individual differences with respect to a desirable depth of the 3D image. On the basis of the above, the present inventors have come up with the idea of a 3D image displaying apparatus allowing the selection of a 3D image having a desirable depth by displaying various 3D images with different depths in list form.

The depth of a 3D image depends on the magnitude of the parallax between images for right eye and for left eye, and the parallax between images for right eye and for left eye varies in magnitude with the position of an object in the images in the depth direction. Specifically, the parallax is larger for an object nearer to a camera during shooting, while smaller for an object farther from the camera. In other words, one 3D image should have various depths for the objects as contained therein. In the interest of simplicity, the 3D image depth hereafter refers to that for the corresponding points which have the largest disparity therebetween, that is to say, the corresponding points which represent a subject nearest to a camera if the amount of displacement between images for right eye and for left eye is zero.

The embodiments of the present invention are described below in reference to the accompanying drawings.

### Embodiment 1

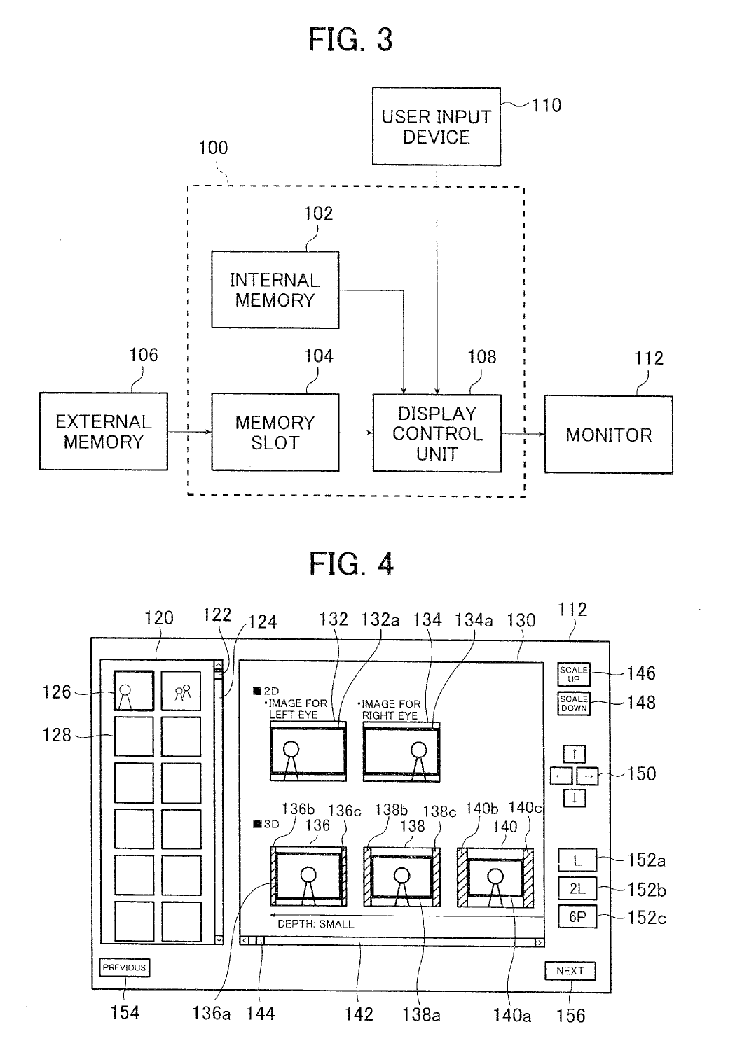

FIG. 3 is a functional block diagram of a 3D image displaying apparatus 100 according to Embodiment 1 of the present invention, showing a principal structure thereof. The 3D image displaying apparatus 100 has a monitor 112 for displaying 3D images, a display control unit 108 for controlling the display on the monitor 112, as well as an internal memory 102 and a memory slot 104 both connected with the display control unit 108. To the memory slot 104, an external memory 106 is connected. The 3D image displaying apparatus 100 of this embodiment is to be used to order the printing of an image. A user viewing images displayed on the monitor 112 selects the image to be printed to place a printing order.

The internal memory 102 is a memory for storing therein the images for right eye and for left eye on which a 3D image is based. Any storage medium is usable as the internal memory 102 as long as images are able to be stored in and read from it, with examples including a hard disk and RAM.

The memory slot 104 is a slot for electrically connecting the 3D image displaying apparatus 100 with the external memory 106. The display control unit 108 can read out the data on images and the like as stored in the external memory 106 if the memory 106 is connected to the memory slot 104. Any storage medium is usable as the external memory 106 as long as images are able to be stored in and read from it, with examples including a flexible disk, a MO disk, a CD-R, a DVD-R, and a flash memory.

The display control unit 108 controls the display on the monitor 112 by converting image data into the format as required by the monitor 112, and outputting the image data to the monitor 112. The display control unit 108 adjusts the depth of a 3D image by adjusting the amount of displacement between images for right eye and for left eye displayed on the monitor 112. Adjustment of the amount of displacement between images for right eye and for left eye is carried out using as the reference the distance between the corresponding points which have the largest disparity therebetween if the images for right eye and for left eye are superimposed on each other. In addition, the display control unit 108 changes the size of a 3D image displayed. The display control unit 108 is realized by a CPU and an operation program causing the CPU to perform various processes. The operation program is stored in the internal memory 102.

A user input device 110 is a device for the input by a user, exemplified by a mouse and a keyboard.

The monitor 112 is a monitor allowing the display of 3D images. The monitor 112 displays images outputted from the display control unit 108. The monitor 112 is capable of the display of 2D images alone, the display of 3D images alone, and the display of both 2D images and 3D images in a mixed manner. Any known technology is applicable to the display of 3D images, with examples including parallax barrier technology.

The 3D image displaying apparatus 100 outputs the image data, which is selected and whose printing is ordered by a user, to a printer through a network or the like.

FIG. 4 shows an exemplary image editing screen displayed on the monitor 112. The image editing screen as shown is a screen displayed on the monitor 112 when a user places an order for printing of an image.

The reduced images, namely thumbnail images, which are obtained by reducing in size a plurality of images as stored in the internal memory 102 or the external memory 106 are displayed in a thumbnail image displaying section 120 located at the left of the monitor 112. In the thumbnail image displaying section 120, thumbnail images as 2D images and those as 3D images are displayed in a mixed manner. The data on a 3D image that is stored in the internal memory 102 or the external memory 106 is composed of the data on an image for right eye, the data on an image for left eye and the tag information which are associated with one another to form data on one 3D image. Tag information includes the 3D image depth with respect to the associated images for right eye and for left eye. The 3D images as stereoscopically displayed in the thumbnail image displaying section 120 have their respective depths which have been stored in advance.

A scroll bar 124 is provided on the right side of the thumbnail image displaying section 120. A knob 122 in the scroll bar 124 is movable in vertical directions in the drawing plane. A user scrolls up or down the images as displayed in the thumbnail image displaying section 120 by using the user input device 110 such as a mouse to drag the knob 122 vertically in the drawing plane. In consequence of such operation, all the images as stored in the internal memory 102 or the external memory 106 are displayed sequentially in the thumbnail image displaying section 120. The user then uses a mouse, for instance, to select from among the thumbnail images as displayed in the thumbnail image displaying section 120 the image which he/she wants to be scaled up. The selected thumbnail image is surrounded by a cursor 126. It should be noted that image selection in the thumbnail image displaying section 120 is in no way the final determination of the image whose printing is to be ordered.

The thumbnail image as selected in the thumbnail image displaying section 120, namely, the image as surrounded by the cursor 126 is scaled up so as to display the scaled-up image in a selected image displaying section 130 located in the middle of the monitor 112. An image displayed in the selected image displaying section 130 is larger than a thumbnail image displayed in the thumbnail image displaying section 120, although not of the original size. If the image as selected in the thumbnail image displaying section 120 is a 2D image, the selected 2D image as such is scaled up and displayed in the selected image displaying section 130.

If the image as selected in the thumbnail image displaying section 120 is a 3D image, the 2D and 3D images which can be generated from the selected 3D image data are displayed in list form in the selected image displaying section 130. To be more specific: In an upper part of the selected image displaying section 130, an image for left eye 132 and an image for right eye 134 are displayed side by side, with the images 132 and 134 constituting the selected 3D image. The image for left eye 132 and the image for right eye 134 are each displayed as a 2D image. On the image for left eye 132 and the image for right eye 134, a frame 132a and a frame 134a are displayed, respectively, in a superimposed manner. Each of the frames 132a and 134a indicates the area of the relevant image that is to be printed if the image is subjected to printing at the designated print size.

In a lower part of the selected image displaying section 130, 3D images 136, 138 and 140 are displayed side by side, whereupon each of the images 136, 138 and 140 can be generated from the selected 3D image data. The 3D images 136, 138 and 140 are different from one another in depth, with the 3D image 136 having the smallest depth, and the 3D image 140 having the largest. In other words, a 3D image displayed in the selected image displaying section 130 at a location nearer to the left end of the section 130 has a smaller depth, while a 3D image displayed at a location nearer to the right end of the section 130 has a larger depth. At the bottom of the selected image displaying section 130, a scroll bar 142 is provided. A user may cause the images which are not displayed at present in the selected image displaying section 130 to be displayed in the section 130 by dragging a knob 144 in the scroll bar 142 in horizontal directions in the drawing plane. As the knob 144 is dragged rightward, 3D images with increasing depths are sequentially displayed in the selected image displaying section 130.

Dark portions 136b and 136c are displayed on the horizontal sides of the 3D image 136, with the portions 136b and 136c being shown by hatching. Similarly, dark portions 138b and 138c are displayed on the horizontal sides of the 3D image 138, and dark portions 140b and 140c are displayed on the horizontal sides of the 3D image 140. The dark portions each represent the size of the area which is cut off from the relevant 3D image as compared with the original image for right eye or for left eye, as a result of the generation of the 3D image by displaying images for right eye and for left eye with a displacement therebetween. The areas to be cut off during the generation of a 3D image are larger as the depth of the 3D image is increased, that is to say, the amount of displacement between images for right eye and for left eye is increased. Accordingly, with respect to the 3D images 136, 138 and 140 as displayed in the selected image displaying section 130 of FIG. 4, the dark portions 136b and 136c are the smallest, while the dark portions 140b and 140c are the largest. Frames 136a, 138a and 140a are displayed on the 3D images 136, 138 and 140, respectively, in a superimposed manner, each indicating the area of the relevant 3D image that is printed if the image is subjected to printing. In the case where a 3D image is to be printed, the area which is not cut off during the generation of the 3D image and, moreover, meets the designated aspect ratio will be printed. Consequently, the frames 136a, 138a and 140a are each displayed with the designated aspect ratio in an area other than the areas corresponding to the dark portions. Since the dark portions are increased with the 3D image depth, a narrower area is printed with a certain scale up for a 3D image with a larger depth even if printing is carried out at the same size.

The image for left eye 132, the image for right eye 134, and the 3D images with different depths are displayed in list form in the selected image displaying section 130, so that a user is able to select the desired image. Specifically, a user is able to determine by comparison whether to print a 2D image or a 3D image because 2D images and 3D images are displayed in list form. In the case where a 2D image is to be selected, it is possible to select a desirable image, either the image for left eye or the image for right eye. If the image for left eye is selected, for instance, printing of the image for left eye can be ordered. The 3D images with different depths as displayed in list form allow a user to specify the depth of a 3D image by comparison. Since the areas at both horizontal ends of a 3D image that are cut off in accordance with the change in the depth of the image are additionally indicated for identification, a user is able to know the extent of such areas.

The depth of the 3D image as selected from among the displayed 3D images may be employed as the depth of a 3D image subsequently selected. It is assumed that, in FIG. 4, the 3D image 136 was selected by a user, for instance. If another 3D image has subsequently been selected in the thumbnail image displaying section 120, the 3D image is allowed to have the same depth as the 3D image 136, and displayed in a central position for 3D images, that is to say, at the location of the 3D image 138. To be more specific, the 3D image as subsequently selected is allowed to have the same distance between corresponding points as that of the 3D image 136, and displayed at the location of the 3D image 138. At the locations of the 3D images 136 and 140, 3D images with depths decreased and increased from the depth of the 3D image as displayed at the location of the 3D image 138 are displayed, respectively. Such a process as above makes it possible to display in list form 3D images with depths modified based on the depth which is considered by a user as desirable for another 3D image and, consequently, display in list form 3D images with depths meeting the intent of the user. The depth of the 3D image as selected from among the displayed 3D images may also be applied to all of other 3D images to be printed. In that case, the 3D images to be printed are identical to one another in depth.

At the right of the monitor 112, a “scale up” button 146, a “scale down” button 148, arrow buttons 150, and print size selecting buttons 152a through 152c are displayed. The “scale up” button 146 and the “scale down” button 148 are used for performing the scale up and the scale down of the selected image, respectively. A user can scale up an image displayed in the selected image displaying section 130 by selecting the “scale up” button 146 with a mouse, for instance. If the “scale down” button 148 is selected, an image displayed in the selected image displaying section 130 is scaled down. The arrow buttons 150 are used for moving the cursor 126 or the like. If the right arrow button is selected, the cursor 126 is moved right, and another image is selected. The print size selecting buttons 152a through 152c are used for selecting the size of the print to be made. On the print size selecting buttons 152a through 152c, symbols, characters, and the like denoting various print sizes are represented. For instance, the print size selecting button 152a which bears letter L is used for placing an order for a print of large size.

In a lower part of the monitor 112, a “previous” button 154 and a “next” button 156 are displayed. The screen as displayed on the monitor 112 is changed into a screen one hierarchical level higher by pressing the “previous” button 154. A screen one hierarchical level higher refers to, for instance, a screen for selecting the memory from which image data are read. The screen as displayed on the monitor 112 is changed into a screen one hierarchical level lower by pressing the “next” button 156. A screen one hierarchical level lower refers to, for instance, a screen for confirming an order for printing of the image as selected in the selected image displaying section 130.

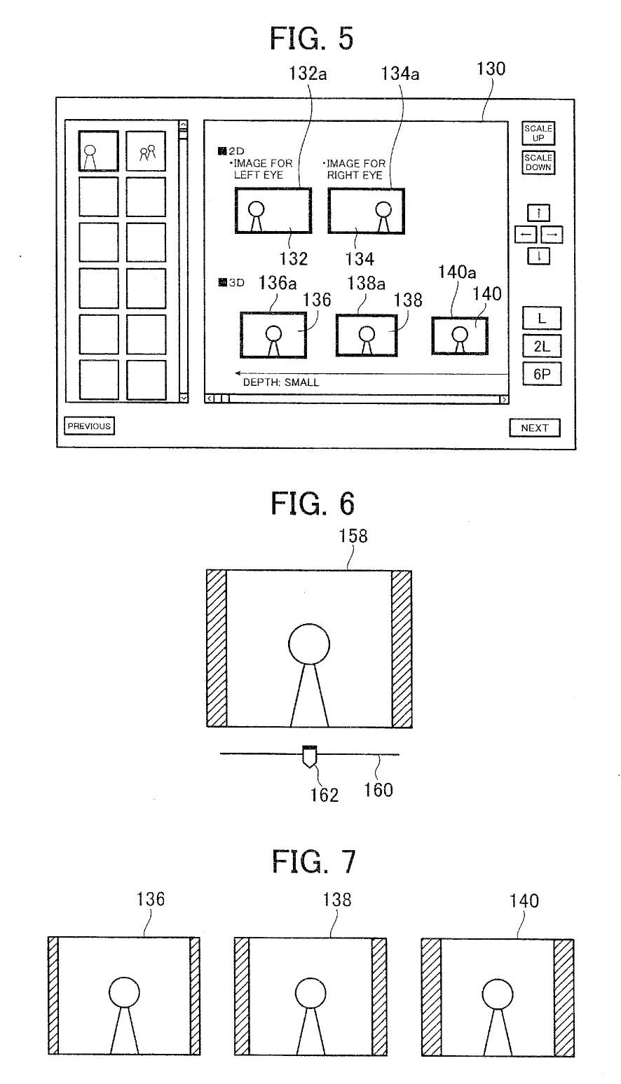

FIG. 5 illustrates another way of displaying images in the selected image displaying section 130. The sole difference between FIGS. 4 and 5 lies in the images as displayed in the selected imaged displaying section 130, so that description is omitted on the elements as shown in FIG. 5 other than the selected image displaying section 130. In FIG. 4, frames indicating the areas to be printed are displayed along with 2D and 3D images so as to indicate the areas distinctively. In FIG. 5, even though frames indicating the areas to be printed are similarly displayed along with 2D and 3D images, areas other than the areas to be printed, that is to say, areas outside the displayed frames are not displayed. The areas which are out of printing are not displayed all along for the purpose of avoiding users' misunderstandings. Since the area of a 3D image that is to be printed is made narrower as the depth of the 3D image is increased, a 3D image displayed nearer to the right end of the section 130 is smaller.

FIG. 6 illustrates another way of displaying 3D images in the selected image displaying section 130. While three 3D images with different depths are displayed at a time in FIGS. 4 and 5, only a 3D image 158 is displayed in FIG. 6. According to the way of displaying as illustrated in FIG. 6, only one 3D image with a specified depth is displayed at a time, whereupon the depth can be changed at will by a user. Specifically, the depth of the 3D image 158 is changed using a bar 160 and a knob 162 displayed under the image 158. The horizontal length of the bar 160 represents the range in which the depth is adjustable, and the position of the knob 162 represents a current depth of the 3D image 158. If the position of the knob 162 is changed, the 3D image 158 is displayed with a depth according to the position which the knob 162 newly occupies with respect to the bar 160. As an example, the 3D image 158 is displayed with the largest depth if the knob 162 is positioned at the right end of the bar 160. In other words, a user is able to change the depth of the 3D image 158 at will by changing the position of the knob 162 using a mouse or the like, which allows the user to select a 3D image depth meeting his/her intent.

FIG. 7 illustrates yet another way of displaying 3D images in the selected image displaying section 130. According to the way of displaying as illustrated in FIG. 7, only one 3D image with a specified depth is displayed at a time, as is the case with FIG. 6, whereupon the 3D image depth is caused to vary with time. As an example, the 3D images 136, 138 and 140 with different depths are displayed at the same location alternately at intervals of three seconds. In other words, the 3D image depth varies with time in three steps. If the depth of the 3D image as displayed at one and the same location is caused to vary with time, the variation in 3D image depth will be more distinct to a user.

In the case where only one 3D image is displayed at a time, with its depth being changed at will or automatically, as described above in reference to FIGS. 6 and 7, space for one 3D image is enough for the display of 3D images, that is to say, displaying space can be reduced in comparison with the case where a plurality of 3D images are displayed in list form.

The 3D image displaying apparatus 100 according to Embodiment 1 of the present invention as described above allows a user to select a desired 2D image or a 3D image giving a desired stereoscopic impression because 2D images and a plurality of 3D images with different depths are displayed in list form in the apparatus.

If scaling up or down of a 3D image is performed in the 3D display unit 8, the distance between corresponding points varies, so that the depth of the 3D image varies accordingly. The depth of a 3D image also varies with the size at which the image is printed, with a smaller print size causing a reduced depth. In consequence, the 3D image as printed at a small size may not appear stereoscopic due to too small a depth selected by a user.

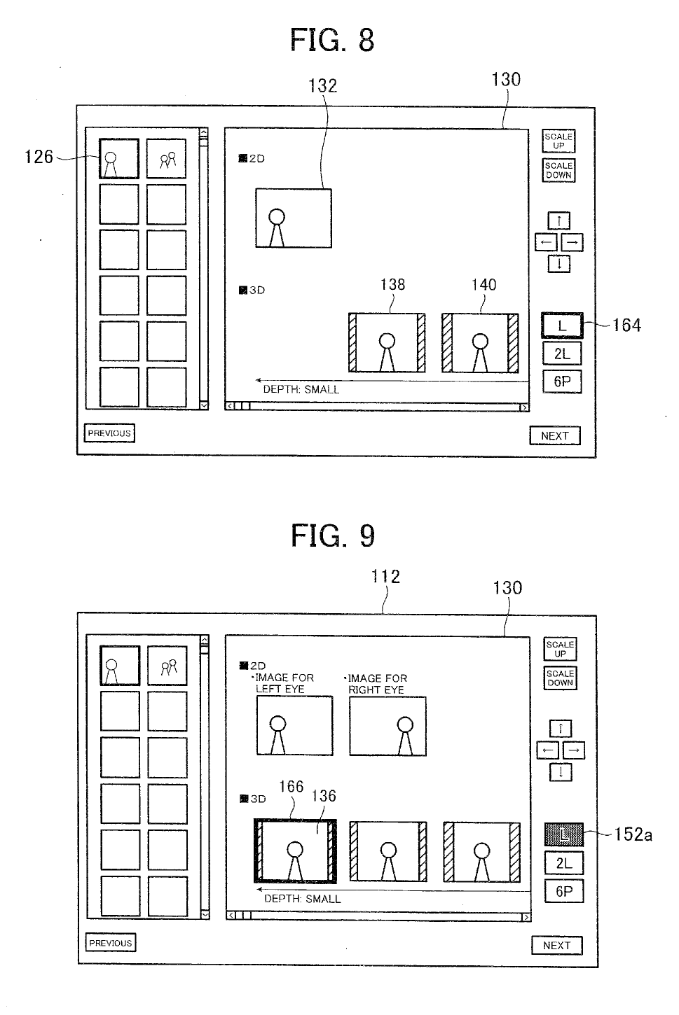

In order to prevent the above, such an image editing screen as shown in FIG. 8 is thinkable. The screen of FIG. 8 is another exemplary image editing screen displayed on the monitor 112. It is assumed that, after a thumbnail image had been selected by the cursor 126, the print size was selected by a cursor 164 with no image selected in the selected image displaying section 130.

In FIG. 8, 3D images displayed in the selected image displaying section 130 are exclusively those which have depths making them appear to a user stereoscopic when printed at the selected print size. As an example, while the 3D images 138 and 140 are displayed, the 3D image 136 with the smallest depth is not displayed, and is accordingly not able to be selected. In other words, the 3D image as such does not appear stereoscopic when printed at the selected print size. According to the configuration as shown, a user is able to select a 3D image with a depth appropriate to the print size.

The parallax between images for right eye and for left eye may be slight, that is to say, an image for right eye and an image for left eye may be almost the same in such 3D image data as obtained by shooting a distant subject. In that case, it is not necessary to display both images for right eye and for left eye as 2D images, but only the image for left eye 132 as a 2D image may be displayed, as shown in FIG. 8. In a specific process, an image for right eye and an image for left eye are both displayed if the distance between corresponding points is longer than a specified threshold.

FIG. 9 shows another example of the image editing screen displayed on the monitor 112 that allows a user to select the 3D image depth as appropriate to the print size. It is assumed that a thumbnail images was initially selected by the cursor 126, then the 3D image 136 was selected in the selected image displaying section 130 by a user. The selected 3D image 136 is surrounded by a cursor 166. If a 3D image with a specified depth is selected in the selected image displaying section 130, a print size selecting button indicating the size at which the selected 3D image will be printed to fail in appearing stereoscopic due to its depth is grayed out. In FIG. 9, the print size selecting button 152a is grayed out because a large-size print of the 3D image 136 will give no stereoscopic impression due to the depth of the image. In other words, such graying out alerts that the 3D image as printed at the size in question will not appear stereoscopic. It is also possible for a user to ignore the alert and select large-size printing. The various processes as described above in reference to FIGS. 8 and 9 are performed based on the table which is defined in advance with respect to the print size, and the shortest distance between corresponding points which allows a print of specified print size to appear stereoscopic. The table is stored in the internal memory 102.

In the present embodiment, the depth of a 3D image may vary with time not at intervals of three seconds but at other time intervals. In addition, the variation in 3D image depth may not be caused in three steps.

### Embodiment 2

In Embodiment 2, the 3D images with different depths that are generated from various combinations of 2D images are displayed in list form, in contrast to Embodiment 1 in which two 2D images, and 3D images with different depths generated from the two 2D images are displayed in list form.

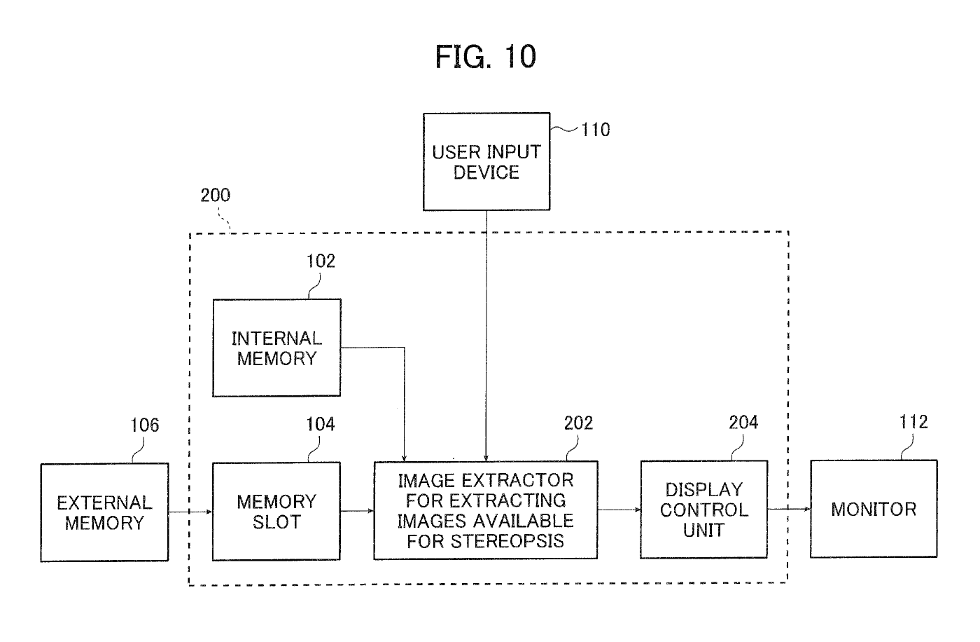

FIG. 10 is a functional block diagram of a 3D image displaying apparatus 200 according to Embodiment 2 of the present invention, showing a principal structure thereof. Components similar to those of the 3D image displaying apparatus 100 are shown with the same numerals, with no further description being made on them.

An image extractor 202 for extracting images available for stereopsis extracts, from the images as stored in an internal memory 102 or an external memory 106, the images two out of which are available in combination for stereopsis. The image extractor 202 extracts images meeting predetermined conditions, with a specific extraction method being detailed later. The process of extraction based on predetermined conditions is performed on all the images stored in the memory as selected by a user.

The images two out of which are available in combination for stereopsis are the images of the same subject which were taken with similar compositions. Examples of the predetermined conditions for the extraction of images available for stereopsis include the condition that a group of the images as contained in a Multi-Picture format (MPF) file should be extracted. In a MPF file, a plurality of 2D images are associated with one another and stored as one file. This file format is chiefly used if 2D images available for stereopsis are to be associated with one another and stored. Consequently, a combination of the 2D images as contained in a MPF file is likely to be a combination of images available for stereopsis. If a twin-lens reflex camera is used to take two images, for instance, the two images are associated with each other and stored as a MPF file. In addition, two or more images of the same subject as taken with a camera horizontally moved with respect to the subject may optionally be stored as a MPF file. Therefore, if a group of images are extracted based on the file format, it is highly possible that a 3D image is generated from a combination of two out of the extracted images.

Another example of the predetermined conditions for the extraction of images available for stereopsis is the condition that a group of the images as taken at short time intervals should be extracted. In recent digital cameras, the shooting date and time are stored for each shot, even to the extent of seconds, as tag information. Generally speaking, the images as taken at time intervals of several seconds or shorter are often images of the same subject. Therefore, if the images as taken at time intervals of several seconds or shorter are extracted based on the tag information, it is highly possible that a 3D image is generated from a combination of two out of the extracted images. As an example, the images as taken at time intervals not longer than two seconds are extracted.

Yet another example of the predetermined conditions for the extraction of images available for stereopsis is the condition that images sharing a subject and the composition should be extracted. In the extraction process under such condition, image analysis is conducted so as to determine whether or not the same subject has been shot with similar compositions. If the images of the same subject as taken with similar compositions are extracted, it is highly possible that a 3D image is generated from a combination of two out of the extracted images.

It is thinkable as a predetermined condition for the extraction of images available for stereopsis to utilize position information based on the Global Positioning System (GPS). If an image is taken with a digital camera having a GPS function, position information based on the GPS is recorded in the tag information. Generally speaking, images closely resembling one another in position information are likely to be images of the same subject. Therefore, if images closely resembling one another in position information based on the GPS are extracted, it is highly possible that a 3D image is generated from a combination of two out of the extracted images. Depending on the accuracy of the GPS function, images closely resembling one another in position information are exemplified by the images which have a position information difference not exceeding two meters between them.

It is also thinkable as a predetermined condition for the extraction of images available for stereopsis to extract a group of the images as taken successively in continuous shooting mode. A group of the images as taken successively in continuous shooting mode can be extracted based on the tag information because it is recorded in the tag information that the images were taken in continuous shooting mode. The images as taken successively in continuous shooting mode are likely to be images of the same subject. Therefore, if a group of the images as taken successively in continuous shooting mode are extracted based on the tag information, it is highly possible that a 3D image is generated from a combination of two out of the extracted images. Moreover, images taken in continuous shooting mode are those taken at short intervals.

It is also thinkable as a predetermined condition for the extraction of images available for stereopsis to extract a group of still images constituting a moving image. The moving image as taken with a digital camera consists of a cluster of still images. It is often the case that the same subject is shot when a moving image is taken. In other words, a group of still images constituting a moving image are likely to be images of the same subject. Therefore, if still images constituting a moving image are extracted, it is highly possible that a 3D image is generated from a combination of two out of the extracted images. A moving image and a still image can be distinguished from each other by the file format.

Such predetermined conditions for the extraction of images available for stereopsis as described above may be employed alone or in combination. As an example, the condition that the images as taken at short time intervals should be extracted and the condition that images sharing a subject and the composition should be extracted are combined with each other so as to extract the images sharing a subject and the composition that were taken at time intervals not longer than two seconds.

A display control unit 204 not only has the functions of the display control unit 108 but causes the images as extracted by the image extractor 202 for extracting images available for stereopsis to be displayed on a monitor 112, in accordance with a method described later. The image extractor 202 and the display control unit 204 are realized by a CPU and an operation program causing the CPU to perform various processes. The operation program is stored in the internal memory 102.

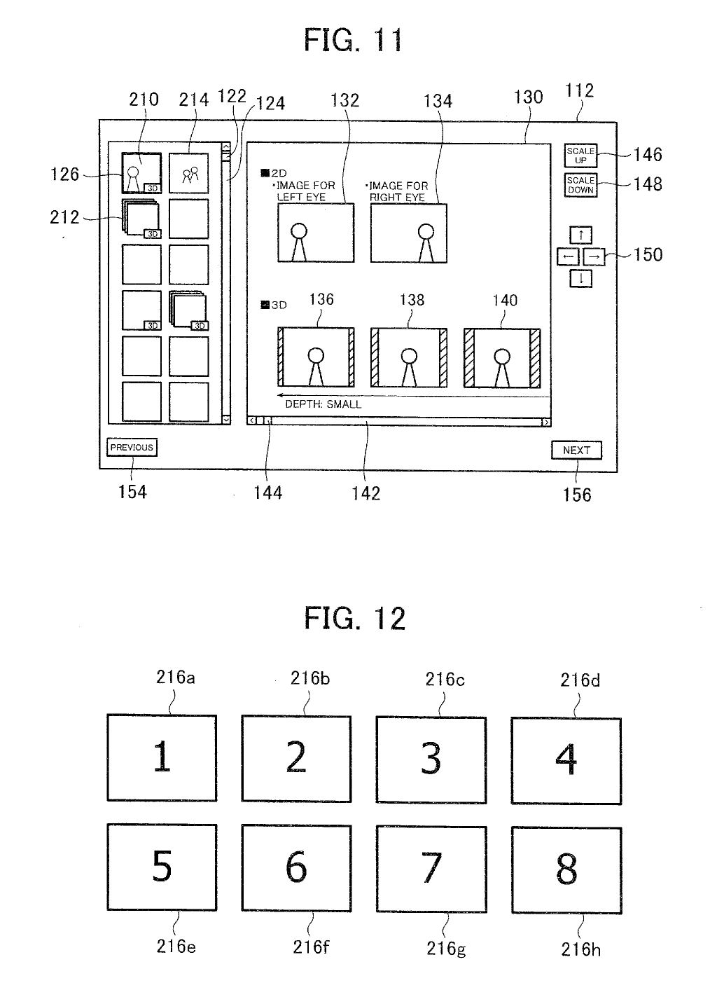

FIG. 11 shows an example of an image editing screen displayed on the monitor 112 of Embodiment 2. Elements similar to those of FIG. 4 are shown with the same numerals, with no further description being made on them.

In a thumbnail image displaying section 120, the image data as stored in the internal memory 102 or the external memory 106 are displayed for identification in the form of thumbnail images after they are classified in three categories. In this regard, single image data including no pieces of image data allowing the generation of a 3D image is placed in a first category, the image data from which two pieces of image data allowing the generation of a 3D image have been extracted is placed in a second category, and the image data from which three or more pieces of image data allowing the generation of a 3D image have been extracted is placed in a third category. In other words, in the thumbnail image displaying section 120, thumbnail images derived from the image data in the above three categories, respectively, are displayed in a mixed manner. Classification of image data is performed by the image extractor 202 for extracting images available for stereopsis, based on the results of the extraction of images available for stereopsis.

The image data as classified in three categories are so displayed as to be distinguished from one another in category even in the form of thumbnail images. To be more specific: The thumbnail image which represents pieces of image data allowing the generation of a 3D image has at its lower right the label reading 3D as displayed thereon in a superimposed manner. On the other hand, nothing is displayed on the thumbnail image which represents image data including no pieces of image data allowing the generation of a 3D image, namely, 2D image data.

There are two ways of displaying the thumbnail image which represents pieces of image data allowing the generation of a 3D image. A thumbnail image 210 is displayed as a reduced version of one image. The thumbnail image 210 as such indicates that two pieces of 2D image data as extracted by the image extractor 202 for extracting images available for stereopsis are included therein. A thumbnail image 212 is displayed as a plurality of thumbnail images stacked. The thumbnail image 212 as such indicates that three or more pieces of 2D image data as extracted by the image extractor 202 are included therein.

The two 2D images to be extracted by the image extractor 202 for extracting images available for stereopsis are images for right eye and for left eye included in a MPF file, for instance. If the thumbnail image 210 is selected by a cursor 126, 2D images included in the thumbnail image 210, and 3D images with different depths generated from the 2D images are displayed in list form in a selected image displaying section 130, just as in the selected image displaying section 130 of FIG. 4.

It is assumed that eight 2D images 216a through 216h shown in FIG. 12 are included in the thumbnail image 212.

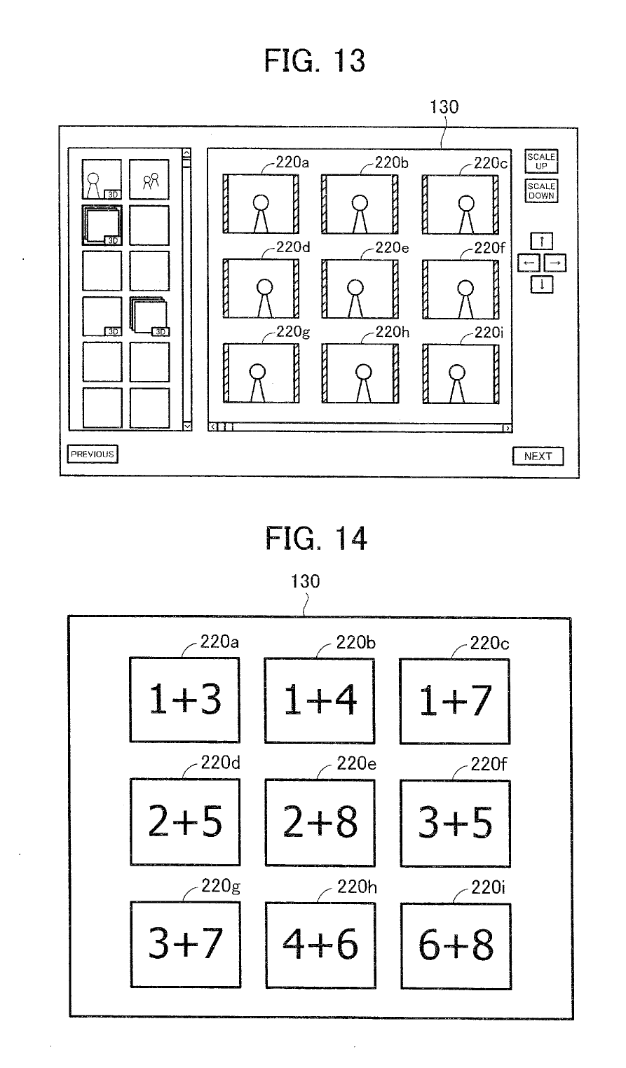

FIG. 13 shows exemplary images displayed in the selected image displaying section 130 after the thumbnail image 212 is selected by the cursor 126. With respect to FIG. 13, description is only made on elements different from those shown in FIG. 11.

In the selected image displaying section 130, 3D images 220a through 220i generated from the 2D images as included in the thumbnail image 212 are displayed in list form. The 3D images 220a through 220i are generated from different combinations of the 2D images 216a through 216h as included in the thumbnail image 212. Specifically, image analysis is conducted on every two out of the eight 2D images as included in the thumbnail image 212 so as to extract a plurality of image sets suitable for the generation of a 3D image, and 3D images generated from the extracted image sets are displayed in list form in the selected image displaying section 130.

In FIG. 14, combinations of 2D images constituting 3D images displayed in the selected image displaying section 130 are represented by the numbers corresponding to those in FIG. 12. According to FIG. 14, the 3D image 220a, for instance, is composed of a combination of the 2D image 216a and the 2D image 216c. The 3D image 220b is composed of a combination of the 2D image 216a and the 2D image 216d. The 3D images 220a through 220i are each composed of a combination of two 2D images different from any other combination, so that they are different from one another in depth.

Since 3D images generated from various combinations of 2D images are thus displayed in list form in the selected image displaying section 130, a user is able to select a 3D image meeting his/her intent without trying for him-/herself a variety of combinations of many 2D images.

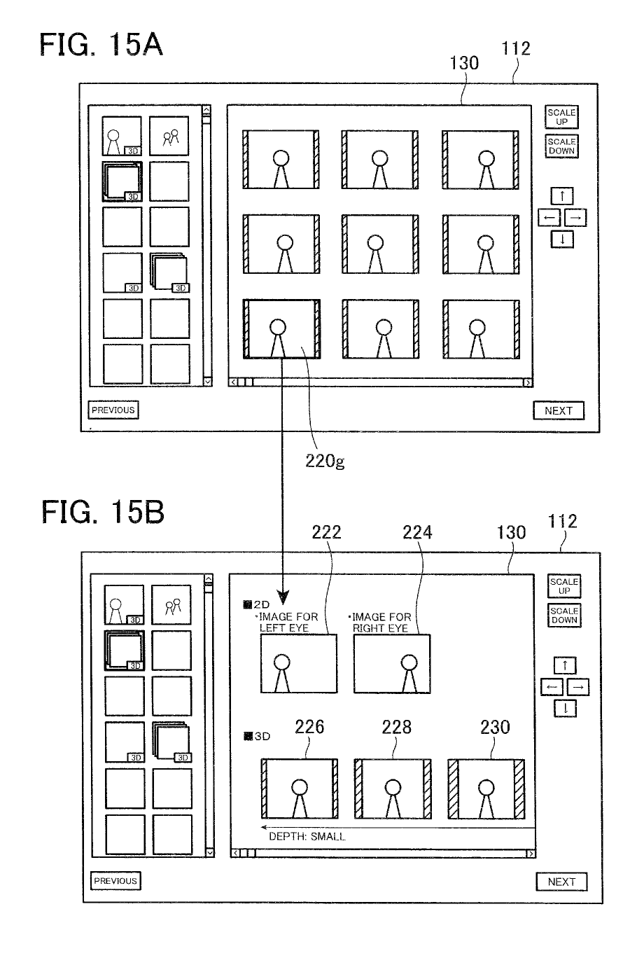

If the image 220g is selected from the 3D images as generated from different combinations of 2D images and displayed in list form as shown in FIG. 15A, a screen shown in FIG. 15B is displayed. In a selected image displaying section 130 of the screen, as shown in FIG. 15B, an image for left eye 222, an image for right eye 224, as well as 3D images 226, 228 and 230 with different depths are displayed in list form. Similar to the screen of FIG. 4, the displayed screen as shown allows a user to select a desired image from among 2D images constituting the 3D image as selected by the user, and 3D images with desirable depths.

As described above, the 3D image displaying apparatus 200 according to Embodiment 2 of the present invention is adapted to extract images available for stereopsis automatically from among the images as stored in a memory. In the apparatus 200, various combinations of the automatically extracted 2D images are displayed in list form as 3D images. Consequently, a user is able to select a desired 3D image from 3D images with different depths generated from various combinations of 2D images.

In the interest of simplicity, print size selecting buttons are omitted from the figures as referred to for the description on the present embodiment. Such buttons may be displayed in Embodiment 2, as is the case with Embodiment 1.

In addition, a print size selecting button indicating the size at which a print of the selected 3D image is not expected to be suitable for stereopsis due to the depth of the image may differently be displayed in the present embodiment apart from Embodiment 1.

Also in the interest of simplicity, frames each having an aspect ratio resulting from the print size and displayed on a 3D image in a superimposed manner are omitted from the figures as referred to for the description on the present embodiment. Such frames may be superimposed on 3D images in Embodiment 2, as is the case with Embodiment 1.

The 3D image whose depth is not considered as suitable for stereopsis based on the selected print size may not be displayed in the present embodiment apart from Embodiment 1.

If different combinations of the automatically extracted images are to be displayed in list form as 3D images in the present embodiment, it is desirable that the 3D images are displayed in such an order that a 3D image derived from the image set which is determined to be more suitable for stereopsis is displayed with a higher priority. The 3D images displayed according to priority are positioned so that, in the case where nine images arranged in an array of 3 rows and 3 columns are to be displayed at a time, for instance, the 3D image as determined to be most suitable for stereopsis may be displayed in the top left corner, while the 3D image as determined to be ninthly most suitable for stereopsis may be displayed in the bottom right corner. The 3D image as determined to be tenthly most suitable for stereopsis and succeeding 3D images may be displayed according to priority by scrolling the 3D images as displayed.

The determination whether or not the image set in question is suitable for stereopsis is made based on such predetermined conditions as described before. If image extraction is to be performed under the condition that the images as taken at short time intervals should be extracted, the image set whose constituent images were taken at shorter time intervals is determined to be more suitable for stereopsis. If image extraction is to be performed under the condition that images sharing a subject and the composition should be extracted, image analysis is conducted to determine the disparity between corresponding points, and the image set in which the parallax is more significant only with respect to the subject(s) while more negligible with respect to the background is determined to be more suitable for stereopsis. If image extraction is to be performed under the condition that images closely resembling each other in position information should be extracted, the image set whose constituent images resemble each other in position information more closely is determined to be more suitable for stereopsis. It is also possible to arrange 3D images in such an order that a 3D image with an earlier shooting time is positioned with a higher priority, or a 3D image having a larger depth, namely, a larger disparity between corresponding points is positioned with a higher priority. If 3D images are to be arranged according to the shooting time, the images are ordered referring to an earlier shooting time of either constituent image of each image set.

While an image set constituting a 3D image is composed of images automatically combined with each other in the present embodiment, it is also possible that a user freely combines images together into an image set. As an example, if the thumbnail image 212 was selected, the 2D images as included in the thumbnail image 212 are displayed in list form in the selected image displaying section 130 as shown in FIG. 12, which allows a user to select any two out of the displayed 2D images. A 3D image generated from the selected two 2D images is displayed in the selected image displaying section 130. As a result, the user is able to confirm a 3D image generated from the two 2D images as selected by him/her.

In the case where a user freely selects two 2D images for the generation of a 3D image as described above, the 2D images which will each bring about a more desirable 3D image if combined with the first 2D image as selected by a user may be indicated distinctively as shown in FIG. 16. It is assumed in FIG. 16 that a user selected the 2D image 216a as the first constituent image of an image set constituting a 3D image. The selected 2D image 216a is surrounded by a cursor 232. After the 2D image 216a was selected, the 2D image which allows generation of a desirable 3D image if combined with the 2D image 216a is surrounded by a cursor displayed with broken lines. In the case as shown, the 2D images 216d, 216f and 216g are surrounded by cursors 234d, 234f and 234g each displayed with broken lines, respectively, after the 2D image 216a was selected. In other words, in FIG. 16, the 2D images 216d, 216f and 216g each bring about a desirable 3D image if combined with the 2D image 216a. The determination whether or not the 2D image in question brings about a desirable 3D image if combined with the selected 2D image is made based on such predetermined conditions as described before. As an example, a cursor displayed with broken lines is emerged around the 2D image which was extracted under a severer condition for the extraction of the displayed 2D images. To be more specific: If the eight 2D images as taken at time intervals not longer than two seconds were extracted under the condition that the images as taken at short time intervals should be extracted, the 2D image which was taken not more than one second before or after the selected 2D image was taken is surrounded by a cursor displayed with broken lines.

The determination whether or not the 2D image in question brings about a desirable 3D image may also be made based on a condition other than that for the extraction of the displayed 2D images. As an example, if the eight 2D images as taken at time intervals not longer than two seconds were extracted under the condition that the images as taken at short time intervals should be extracted, the 2D image which has a position information difference not exceeding one meter between itself and the selected 2D image is surrounded by a cursor displayed with broken lines.

After the 2D image to be combined with the selected 2D image 216a was selected, a 3D image generated from the image set as composed of the two 2D images is displayed in a lower part of the selected image displaying section 130.

In each of the embodiments as described above, the monitor 112 may be an external display unit, or an input device such as a touch panel may be provided as the monitor. While it is desirable that the monitor 112 is a display device capable of displaying 2D and 3D images in a mixed manner, the monitor 112 may be a display device allowing selection of the images to be displayed, either 2D images or 3D images. If the display of 3D images is selected, 3D images are only displayed on the monitor, whereupon 3D images generated from the same image for right eye are displayed in a part of the monitor adapted for the display of an image for right eye, and 3D images generated from the same image for left eye are displayed in a part adapted for the display of an image for left eye. In this way, images for left eye and for right eye can be displayed as 2D images even though the monitor is not capable of displaying 2D and 3D imaged in a mixed manner.

In each of the embodiments as described above, images may be displayed in list form in a number higher or lower than those employed in the above description. It is also possible that the number of the images to be displayed in list form is specified at will by a user.

In each of the embodiments as described above, it is not required that only one image is selected in the displayed screen. For instance, two images, such as an image for left eye and a 3D image, may be selected so as to designate their printing.

In each of the embodiments as described above, adjustment of the 3D image depth is performed using a combination of a bar and a knob, to which the interface to be used for the 3D image depth adjustment is not limited. Use of a “+/−” button, direct input of numerical values, selection of a large, medium or small depth from the drop-down list, and so forth are thinkable.

While a 3D image is generated from two 2D images in each of the embodiments as described above, the present invention is also applicable to the case where a 3D image is generated from three or more 2D images. If a 3D image is to be generated from eight 2D images, eight or more 2D images are extracted from those stored in a memory.

The display of 3D images on the monitor 112 as performed in each of the embodiments as described above can be carried out by a 3D image displaying method including the step of displaying a 3D image on a 3D image displaying device by displaying two or more 2D images sharing at least part of shot subjects with one another so that at least a portion of the 2D images may be perceived by a viewer as a stereo image with a specified depth; the step of causing a plurality of 3D images displayed on the 3D image displaying device to vary in depth; and the step of displaying in list form the 3D images as caused to vary in depth on the 3D image displaying device.

A 3D image displaying program for putting a computer in operation in response to various functions of the 3D image displaying apparatus according to the embodiments of the present invention as described above, and a 3D image displaying program for causing a computer to perform as its procedures the steps of the 3D image displaying method as above are each an embodiment of the present invention. In addition, a computer readable storage medium with such a program recorded therein is an embodiment of the present invention.

The embodiments of the present invention as described above merely exemplify the present invention, putting no limitations on the configuration of the present invention. Any of the 3D image displaying apparatus, the 3D image displaying method, the 3D image displaying program, and a recording medium having the 3D image displaying program recorded thereon according to the present invention is not limited to the above embodiments but may be modified miscellaneously and implemented within the scope of the present invention.

The 3D image displaying apparatus, the 3D image displaying method, the 3D image displaying program, and a recording medium having the 3D image displaying program recorded thereon according to the present invention can be used to edit 3D images so as to allow a user to select with ease the 3D image with a desired depth which gives a desired stereoscopic impression.

What is claimed is:

1. A three-dimensional image displaying apparatus comprising:
a three-dimensional image displaying device for displaying a plurality of two-dimensional images sharing at least part of shot subjects with one another so as to display a three-dimensional image in which at least a portion of the two-dimensional images is perceived by a viewer as a stereo image with a specified depth; and
a display controlling device for making a depth of the three-dimensional image vary so as to provide a plurality of three-dimensional images with different depths, and causing the three-dimensional images with different depths to be displayed in list form on the three-dimensional image displaying device.

2. The three-dimensional image displaying apparatus according to claim 1, further comprising:
an image extracting device for extracting from a plurality of two-dimensional images stored in a storage medium those two-dimensional images which are displayable by said three-dimensional image displaying device as a three-dimensional image if they are combined together, wherein:
said display controlling device makes the depth of said three-dimensional image vary by forming different combinations of the two-dimensional images as extracted by the image extracting device, and causes three-dimensional images generated from the different combinations of the two-dimensional images to be displayed in list form on the three-dimensional image displaying device.

3. The three-dimensional image displaying apparatus according to claim 1, wherein:
said display controlling device makes the depth of said three-dimensional image vary by displacing said two-dimensional images displayed on said three-dimensional image displaying device.

4. The three-dimensional image displaying apparatus according to claim 3, wherein:
said display controlling device causes a plurality of two-dimensional images constituting said three-dimensional images with different depths to be displayed as two-dimensional images along with the three-dimensional images, with the three-dimensional images and the two-dimensional images being displayed in list form.

5. The three-dimensional image displaying apparatus according to claim 2, wherein:
said image extracting device extracts said two-dimensional images which meet a predetermined condition, based on a file format, image analysis, or two-dimensional image tag information.

6. The three-dimensional image displaying apparatus according to claim 5, wherein:
said display controlling device causes three-dimensional images to be displayed in list form in such an order that a three-dimensional image determined to be more suitable for stereopsis based on said predetermined condition is displayed with a higher priority.

7. The three-dimensional image displaying apparatus according to claim 1, wherein:
said display controlling device causes an area cut off during generation of said three-dimensional image to be displayed along with the three-dimensional image.

8. The three-dimensional image displaying apparatus according to claim 1, wherein said three-dimensional images with different depths as displayed on said three-dimensional image displaying device are three-dimensional images displayed in order to select from among them those to be printed.

9. The three-dimensional image displaying apparatus according to claim 1, further comprising a device for selecting a three-dimensional image to be printed from among said three-dimensional images with different depths as displayed on said three-dimensional image displaying device.

10. The three-dimensional image displaying apparatus according to claim 1, further comprising a print size designating device for designating a print size for an image, wherein:
said display controlling device causes a frame with an aspect ratio resulting from the print size as designated by the print size designating device to be displayed so that it may be superimposed on said three-dimensional image.

11. A three-dimensional image displaying method for displaying a plurality of three-dimensional images, each being constructed from a two-dimensional image pair composed of two two-dimensional images taken, wherein:
the three-dimensional images to be displayed are different from one another in depth, and are displayed in list form; and
the three-dimensional images to be displayed share at least part of shot subjects with one another.

12. A three-dimensional image displaying program for causing a computer to perform as its procedures:
a display step of displaying a plurality of two-dimensional images sharing at least part of shot subjects with one another so as to display a three-dimensional image in which at least a portion of the two-dimensional images is perceived by a viewer as a stereo image with a specified depth; and
a control step of carrying out control so that three-dimensional images differing from one another in depth may be displayed in list form in the display step.

13. A computer readable storage medium with the three-dimensional image displaying program according to claim 12 stored therein.
